(19) United States
(12) Patent Application Publication
(10) Pub. No.: US 2013/0325559 A1
(43) Pub. Date: Dec. 5, 2013

(54) ACTIONABLE BUSINESS ENTITY OPERATING MODEL

(71) Applicants: STAN KEVIN DALEY, Atlanta, GA (US); Thomas T. Hanis, Raleigh, NC (US); Claus T. Jensen, Pawling, NY (US); Eoin Lane, Littleton, MA (US)

(72) Inventors: STAN KEVIN DALEY, Atlanta, GA (US); Thomas T. Hanis, Raleigh, NC (US); Claus T. Jensen, Pawling, NY (US); Eoin Lane, Littleton, MA (US)

(73) Assignee: International Business Machines Corporation, Armonk, NY (US)

(21) Appl. No.: 13/482,862

(22) Filed: May 29, 2012

(51) Int. Cl. G06Q 10/06

(52) U.S. Cl. 705/7.36

(57) ABSTRACT

Illustrative embodiments include a method, system, and computer program product for creating an actionable business environment model. A business object is instantiated according to a business entity subclass, the business entity subclass representing an asset in a business environment. An event object is instantiated, wherein an event represented in the event object applies to the business object. A decision object is instantiated, wherein the decision object includes logic to take an action in response to the event. An action object is instantiated, wherein the action object includes logic to respond to the event by interacting with the business object. The business object is made actionable by relating the business object with a combination of the event object, the decision object, and the action object using a declarative statement. The actionable business object is added to a model, thereby creating the actionable business model.

### TECHNICAL FIELD

The present invention relates generally to a method, system, and computer program product for configuring a business environment. Particularly, the present invention relates to a method, system, and computer program product for making a business entity operating model actionable.

### BACKGROUND

A business environment is a collection of business entities, such as equipment, assets, organizations, people, locations, and data. Furthermore, the business entities are related to one another through certain relationships and connections. For example, a fan is connected to a switch, a compressor is a part of an HVAC unit, a role in an organization depends upon a set of other roles in the organization, and a sensor in the business environment produces data for a repository.

A model of a business environment is useful for a variety of reasons. For example, a piece of equipment can be suitably configured when the equipment's relationships are known and configured correctly. As an example, a power supply may be an asset in a given business environment. An operator in the business environment creates business objects representations of the power supply and the various pieces of equipment that depend on the power supply. The operator configures these business objects relative to one another in code in the form of a model of the business environment.

Such a model is a business environment model, and is also called a business entity operating model. A formal language for expressing a model of a business environment and the business objects representing the business entities therein is called Reference Semantic Model (RSM).

Some tools exist for creating RSMs. Typically, an RSM tool is industry specific and facilitates creating a business environment model by providing an operator a collection of representations of common business entities found in the business environment of a particular industry. For example, for modeling an oil and gas operation, an operator may select an RSM tool that provides a library of business objects representing equipment and other assets commonly found in the oil and gas industry. An actions-handling mechanism relative to those business objects is not available in RSM. The operator presently has to write custom code to configure the specific attributes of those objects, events in the given environment, and the desired actions relative to those objects in the given environment.

### SUMMARY

The illustrative embodiments provide a method, system, and computer program product for actionable business entity operating model. In at least one embodiment, a method for creating an actionable business environment model is provided. The method includes a computer instantiating a business object according to a business entity subclass, the business entity subclass representing an asset in a business environment. The method further includes the computer instantiating an event object, wherein an event represented in the event object applies to the business object. The method further includes the computer instantiating a decision object, wherein the decision object includes logic to take an action in response to the event. The method further includes the computer instantiating an action object, wherein the action object includes logic to respond to the event by interacting with the business object. The method further includes the computer making the business object actionably by relating the business object to a combination of the event object, the decision object, and the action object using a declarative statement. The method further includes the computer adding the actionable business object to a model, thereby creating the actionable business environment model.

In at least one embodiment, a method for configuring a business entity object in an actionable business environment model is provided. The method includes a computer instantiating a business object according to a business entity subclass, the business entity subclass representing an asset in a business environment. The method further includes the computer instantiating a data provider object, wherein the data provider object supplies data to an attribute of the business object. The method further includes the computer relating the business object and the data provider object using a declarative statement, wherein the business object and the data provider object related using the declarative statement form a part of the actionable business environment model.

In at least one embodiment, a computer program product for creating an actionable business environment model is provided. The computer program product includes one or more computer-readable tangible storage devices. The computer program product further includes program instructions, stored on at least one of the one or more storage devices, to instantiate a business object according to a business entity subclass, the business entity subclass representing an asset in a business environment. The computer program product further includes program instructions, stored on at least one of the one or more storage devices, to instantiate an event object, wherein an event represented in the event object applies to the business object. The computer program product further includes program instructions, stored on at least one of the one or more storage devices, to instantiate a decision object, wherein the decision object includes logic to take an action in response to the event. The computer program product further includes program instructions, stored on at least one of the one or more storage devices, to instantiate an action object, wherein the action object includes logic to respond to the event by interacting with the business object. The computer program product further includes program instructions, stored on at least one of the one or more storage devices, to make the business object actionable by relating the business object to a combination of the event object, the decision object, and the action object using a declarative statement. The computer program product further includes program instructions, stored on at least one of the one or more storage devices, to add the actionable business object to a model, thereby creating the actionable business environment model.

In at least one embodiment, a computer program product for configuring a business entity object in an actionable business environment model is provided. The computer program product includes one or more computer-readable tangible storage devices. The computer program product further includes program instructions, stored on at least one of the one or more storage devices, to instantiate a business object according to a business entity subclass, the business entity subclass representing an asset in a business environment. The computer program product further includes program instructions, stored on at least one of the one or more storage devices, to instantiate a data provider object, wherein the data provider object supplies data to an attribute of the business object. The computer program product further includes program instructions, stored on at least one of the one or more storage devices, to relate the business object and the data provider object using a declarative statement, wherein the business object and the data provider object related using the declarative statement form a part of the actionable business environment model.

In at least one embodiment, a computer system for creating an actionable business environment model is provided. The computer system includes one or more processors, one or more computer-readable memories and one or more computer-readable tangible storage devices. The computer system further includes program instructions, stored on at least one of the one or more storage devices for execution by at least one of the one or more processors via at least one of the one or more memories, to instantiate a business object according to a business entity subclass, the business entity subclass representing an asset in a business environment. The computer system further includes program instructions, stored on at least one of the one or more storage devices for execution by at least one of the one or more processors via at least one of the one or more memories, to instantiate an event object, wherein an event represented in the event object applies to the business object. The computer system further includes program instructions, stored on at least one of the one or more storage devices for execution by at least one of the one or more processors via at least one of the one or more memories, to instantiate a decision object, wherein the decision object includes logic to take an action in response to the event. The computer system further includes program instructions, stored on at least one of the one or more storage devices for execution by at least one of the one or more processors via at least one of the one or more memories, to instantiate an action object, wherein the action object includes logic to respond to the event by interacting with the business object. The computer system further includes program instructions, stored on at least one of the one or more storage devices for execution by at least one of the one or more processors via at least one of the one or more memories, to make the business object actionable by relating the business object to a combination of the event object, the decision object, and the action object using a declarative statement. The computer system further includes program instructions, stored on at least one of the one or more storage devices for execution by at least one of the one or more processors via at least one of the one or more memories, to add the actionable business object to a model, thereby creating the actionable business environment model.

In at least one embodiment, a computer system for configuring an actionable business environment model is provided. The computer system includes one or more processors, one or more computer-readable memories and one or more computer-readable tangible storage devices. The computer system further includes program instructions, stored on at least one of the one or more storage devices for execution by at least one of the one or more processors via at least one of the one or more memories, to instantiate a business object according to a business entity subclass, the business entity subclass representing an asset in a business environment. The computer system further includes program instructions, stored on at least one of the one or more storage devices for execution by at least one of the one or more processors via at least one of the one or more memories, to instantiate a data provider object, wherein the data provider object supplies data to an attribute of the business object. The computer system further includes program instructions, stored on at least one of the one or more storage devices for execution by at least one of the one or more processors via at least one of the one or more memories, to relate the business object and the data provider object using a declarative statement, wherein the business object and the data provider object related using the declarative statement form a part of the actionable business environment model.

### BRIEF DESCRIPTION OF THE SEVERAL VIEWS OF THE DRAWINGS

The novel features believed characteristic of the invention are set forth in the appended claims. The invention itself, however, including a preferred mode of use, further objectives and advantages thereof, will best be understood by reference to the following detailed description of illustrative embodiments when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a generalized configuration of classes in an improved modeling tool in accordance with an illustrative embodiment;

FIG. 4 depicts an example instantiation of self-updating business objects in an actionable business entity operating model in accordance with an illustrative embodiment;

FIG. 5 depicts an example configuration of actionable business objects in an actionable business entity operating model in accordance with an illustrative embodiment;

FIG. 6 depicts an example of declarative statements replacing custom coding in an actionable business entity operating model in accordance with an illustrative embodiment;

FIG. 7 depicts a flowchart of an example process of creating a self-updating business object for an actionable business entity operating model in accordance with an illustrative embodiment; and

FIG. 8 depicts a flowchart of an example process of creating an actionable business entity operating model in accordance with an illustrative embodiment.

### DETAILED DESCRIPTION

The illustrative embodiments recognize that presently available modeling tools place a significant custom coding burden on an operator of a business environment. For example, some presently available industry-specific RSM tools offer a collection of classes for the various business entities in a generic environment found in that industry. An operator has the burden of custom coding the other aspects of the model using that collection.

The custom coding begins at customizing the classes as may be needed for the operator's specific business environment. Consider, for example, the previous example of a power supply business entity. Once the generic power supply class has been customized according to the power supply equipment existing in the business environment, the operator must write additional custom code. For example, the operator must write custom code for establishing the dependencies of the power supply object on ambient conditions, line voltage fluctuations, and many other factors present in the business environment and the corresponding model. The operator must then write more custom code for the logic for configuring events in the model and detecting those events in the model.

More custom code is needed to associate those events with one or more business objects in the model. The operator must also create custom code for the logic for actions the operator wants to occur in the business environment model, and consequently in the business environment, in response to those events.

The illustrative embodiments recognize that such custom coding for modeling a business environment is disadvantageous for several reasons. For example, the illustrative embodiments recognize that the amount of custom coding distracts the operator of the business environment from operational tasks to creating and managing a model for those operational tasks. The illustrative embodiments further recognize that the custom code is difficult to manage or change as the business environment changes.

Thus, the illustrative embodiments recognize that presently available RSM technology disadvantageously requires significant custom coding of business entities, events, and actions. Consequently, a business entity operating model produced from existing RSM tools is rigid, complex, and inefficient at creation and at runtime.

The illustrative embodiments used to describe the invention generally address and solve the above-described problems and other problems related to modeling business environments. The illustrative embodiments provide a method, system, and computer program product for creating an actionable business entity operating model.

Generally, an embodiment of the invention provides a technique for creating a class hierarchy for business entities such that the objects resulting from those classes can automate certain functions and obviate custom coding. For example, according to one embodiment, an operator need not code a method for updating an attribute in an object representing a business entity (business object). Rather, the operator can reference the business object and an object corresponding to a data provider for an attribute of the business object, as provided by the embodiment, and declaratively form an association between the two objects such that the business object updates itself from the data provider object.

In other words, the operator only provides a declaration that the business object receives data for an attribute from the data provider object, and a runtime engine, such as a model interpreter, forms the data connection when the model is executed.

Furthermore, according to an embodiment, the operator need not code a specific event, code a manner of detecting the event, code a decision making process based on the event, and code an action based on that decision, as in the prior art. Rather, the operator need only make declarative associations between event objects instantiated from event classes in the embodiment, decision objects instantiated from encapsulated decision making processes, and objects instantiated from abstracted actions relevant in a type of business environment. Using the declarative associations or relationships, an embodiment creates an actionable business entity operating model, which includes self-actuating business objects, events, decision making processes, and actions, as described herein.

The illustrative embodiments are described with respect to certain applications and information based thereon only as examples. Such descriptions are not intended to be limiting on the invention. For example, an illustrative embodiment described with respect to an RSM tool can be implemented with a similarly purposed tool or application for modeling business environments within the scope of the illustrative embodiments.

Furthermore, the illustrative embodiments may be implemented with respect to any type of data, data source, or access to a data source over a data network. Any type of data application or storage device may provide the data to an embodiment of the invention, either locally at a data processing system or over a data network, within the scope of the invention.

An embodiment of the invention may be implemented with respect to any type of application, such as, for example, applications that are served, the instances of any type of server application, a platform application, a stand-alone application, an administration application, or a combination thereof. An application, including an application implementing all or part of an embodiment, may further include data objects, code objects, encapsulated instructions, application fragments, services, and other types of resources available in a data processing environment. For example, a Java object, an Enterprise Java Bean (EJB), a servlet, or an applet may be manifestations of an application with respect to which the invention may be implemented (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

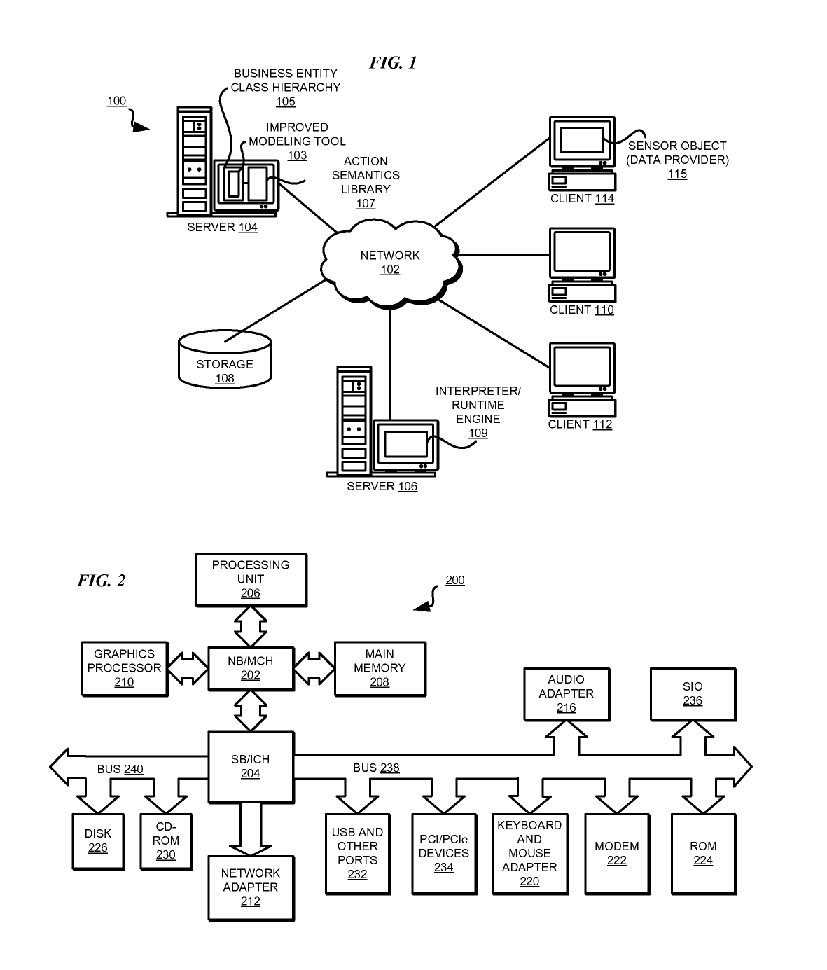

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include example improved modeling tool 103 according to an embodiment. As an example, improved modeling tool 103 uses business entity class hierarchy 105 according to an embodiment. Action semantics library 107 in server 104 is an organization of classes for defining and detecting events in a given business environment, classes for a variety of decision logic, classes defining a variety of actions possible using the events and the decision logic in the given business environment, and classes including logic for determining dependencies between various objects, other similarly usable classes, or a combination thereof. Runtime engine 109 executes in a data processing system, such as server 106. An example of runtime engine 109 is an interpreter that can interpret the declarative statements in a business entity operating model according to an embodiment and execute the model for operating the business environment. Sensor object 115 in a data processing system, such as client 114, is an example of a data provider object that can provide data to an attribute of a business object in accordance with an illustrative embodiment. Any number of data provider objects can execute in any number of data processing systems in a similar manner without limitation.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client/server environment in which the illustrative embodiments may be implemented. A client/server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer or a data processing device, such as server 104, server 106, or client 114 in FIG. 1, in which computer usable program code or instructions implementing the processes for certain illustrative embodiments, such as, for example, the instructions for improved modeling tool 103 in FIG. 1, action semantics library 107 in FIG. 1, runtime engine 109 in FIG. 1, or sensor object 115 in FIG. 1, but not limited there to, may be located.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java programming system, may run in conjunction with the operating system and provides calls to the operating system from Java programs or applications executing on data processing system 200.

Instructions for the operating system, the object-oriented programming system, and applications or programs, such improved modeling tool 103 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

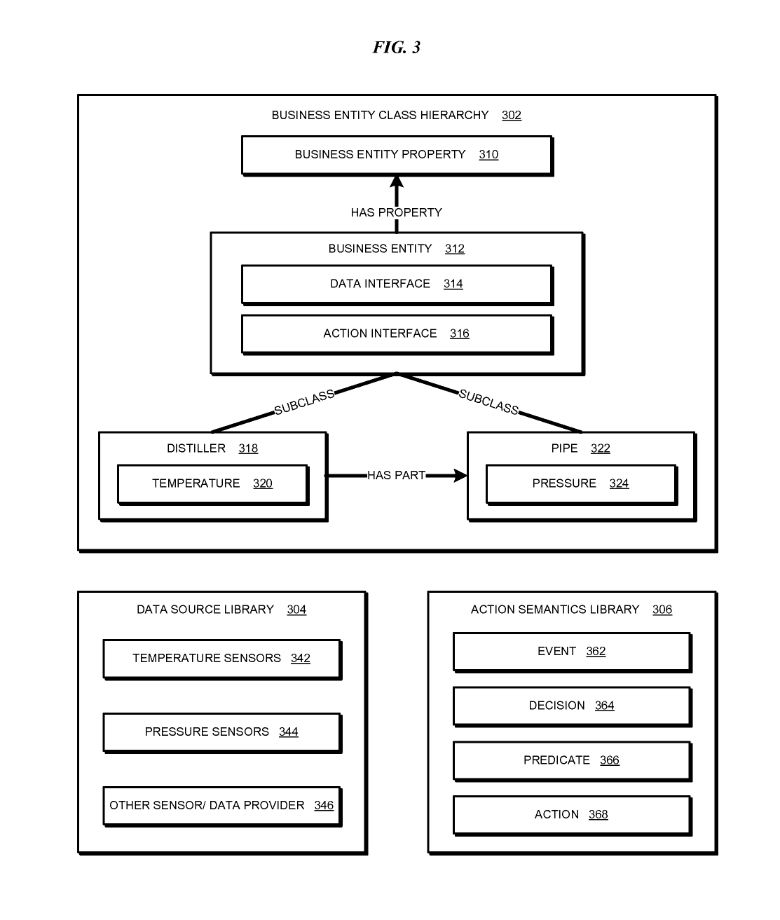

With reference to FIG. 3, this figure depicts a block diagram of a generalized configuration of classes in an improved modeling tool in accordance with an illustrative embodiment. Business entity class hierarchy 302 is usable as business entity class hierarchy 105 in FIG. 1. A class in data source library 304 can be used as sensor 115 in FIG. 1. Action semantics library 306 is usable as action semantics library 107 in FIG. 1.

Business entity class hierarchy 302 is depicted with certain example classes in an example hierarchy and including certain example member attributes or functions without implying any limitation on the illustrative embodiments. Those of ordinary skill in the art will be able to add or modify the depicted hierarchy with more or different classes for representing more or different business entities for different industries, and the same are contemplated within the scope of the illustrative embodiments.

As an example, business entity class hierarchy 302 depicts classes that can be instantiated as business objects for representing equipment and assets commonly found in the oil and gas industry. In contrast with prior art collections of classes for representing the business entities, business entity class hierarchy 302 implements a hierarchy beginning with business entity class 312, which allows integration with other objects to make a business object actionable in a business environment model according to an embodiment.

Business entity class 312 is a parent class for a generic business entity and implements methods for integrating a business object from a class in business entity class hierarchy 302 with action objects from action semantics library 306, a data provider object from data source library 304, or a combination thereof. Business entity class 312 has the properties defined in business entity property 310 via a “has property” relationship.

For example, and without implying any limitation on the illustrative embodiments, business entity class 312 includes data interface 314 to communicate with a data provider object, such as an instance of temperature sensor class 342. As another example, and without implying any limitation on the illustrative embodiments, business entity class 312 includes action interface 316 to communicate with an action object, such as an instance of event detection class 362.

As an example, distiller 318 is a subclass of business entity class 312 and represents distilling equipment commonly found in the oil and gas industry. Distiller class 318 includes example attribute 320, which stores temperature information relevant to a distiller equipment.

As another example, pipe 322 is a subclass of business entity class 312 and represents pipe equipment commonly found in the oil and gas industry. Pipe class 322 includes example attribute 324, which stores pressure information relevant to a pipe equipment. Furthermore, distiller class 318 and pipe class 322 are related to one another by a “has part” relationship because distiller equipment typically includes as a part thereof one or more pipes.

Data source library 304 includes a variety of classes representing a variety of data providers, including but not limited to sensors. Furthermore, the classes in data source library 304 may also be organized in a suitable hierarchy. A class in data source library 304 when instantiated and related to a business object from business entity class hierarchy 302 via a declarative statement according to an embodiment provides data for an attribute of that business object.

For example, in one embodiment, temperature sensors class 342 represents a generic temperature sensor equipment. A specific type of thermal sensor existing in a given business environment can be derived from temperature sensors class 342. In another embodiment, temperature sensors class 342 includes a class representing the specific type of thermal sensor in the given business environment.

Similarly, in one embodiment, pressure sensors class 344 represents a generic pressure sensor equipment. A specific type of pressure sensor existing in a given business environment can be derived from pressure sensors class 344. In another embodiment, pressure sensors class 344 includes a class representing the specific type of pressure sensor in the given business environment.

Any other type of data provider can be similarly represented as class 346 in data source library 304. For example, a connector for a data repository can be encapsulated as class 346 in data source library 304.

Action semantics library 306 is not intended to imply any particular form of library of predefined functions, such as a statically defined library, or a flat collection of statically or dynamically usable functions. In fact, the term “action semantics library” as in action semantics library 306, is used herein to encompass a formal language for describing actions, and action-related artifacts, in a business environment. The formal language can be any formal language, to with, a semantic model, that is configurable and usable for expressing action semantics on business entities.

Furthermore, action semantics library 306 can be hierarchically organized, as contrasted with a flat collection of functions or even action semantics. Action semantics library 306 can be organized as a formal semantic model without being limited to the simplified depiction in FIG. 3. Additionally, although not depicted in FIG. 3 to avoid obscuring the concepts depicted in FIG. 3, relationships such as “applies to,” “triggers,” and other similarly usable relationships are also parts of the action semantics library 306. Specific relationships, such as “applies to” or “triggers”, are depicted and described herein only as parts of an example formal action language, without implying a limitation to instantiations in a particular operating model.

Only as an example to illustrate certain features of an embodiment, action semantics library 306 includes a variety of classes representing a variety of events, detection logic for those events, logic for decision making using detected events, logic for actions to be performed based on those decisions, and dependencies or predicate logic for those actions. The classes in action semantics library 306 may also be organized in a suitable hierarchy. An object formed from instantiating a class in action semantics library 306 is collectively referenced herein as an action object. An action object from action semantics library 306 when related to a business object from business entity class hierarchy 302 via a declarative statement according to an embodiment makes the business object actionable. A set of one or more action objects related to a set of one or more business objects participate in a business enterprise model to make the model an actionable business entity operating model.

As an example, in one embodiment, event class 362 represents a generic event found in a generic business environment. A specific type of event existing in a given business environment can be derived and defined from event class 362. In another embodiment, event class 362 includes a class representing the specific type of event in the given business environment. A class in event class 362 can also include logic for detecting the type of event defined therein.

Similarly, in one embodiment, decision class 364 represents a generic logic for making a decision in response to detecting an event in a generic business environment. A specific type of decision to handle a specific type of event existing in a given business environment can be derived from decision class 364. In another embodiment, decision class 364 includes a class representing the specific type of decision to handle the specific type of event in the given business environment.

Likewise, in one embodiment, predicate class 366 represents a generic logic for determining action predicates in a generic business environment. A specific type of action predicate for a specific action used in a given business environment can be derived from predicate class 366. In another embodiment, predicate class 366 includes a class representing the specific type of action predicate for the specific type of action in the given business environment.

Likewise, in one embodiment, action class 368 represents a generic logic for a generic action relative to a generic business object in a generic business environment. A specific type of action for a specific business object used in a given business environment can be derived from action class 368. In another embodiment, action class 368 includes a class representing the specific type of action for use with the specific type of business object in the given business environment.

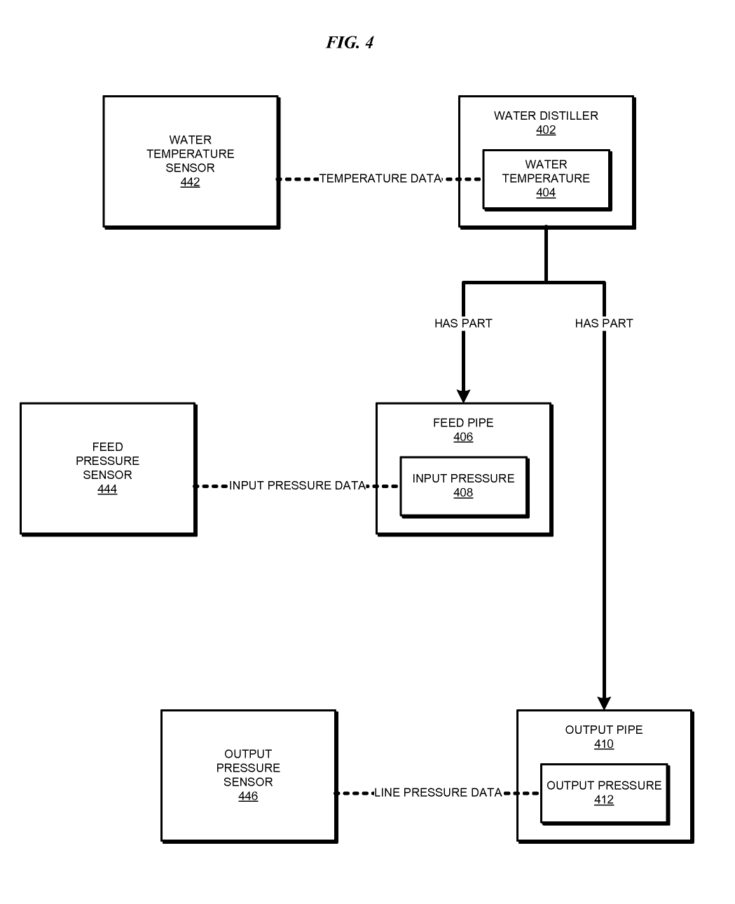

With reference to FIG. 4, this figure depicts an example instantiation of self-updating business objects in an actionable business entity operating model in accordance with an illustrative embodiment. Water distiller 402 is a business object that is instantiated from distiller class 318 or a derivative or modification thereof in FIG. 3. Water temperature 404 is analogous to temperature attribute 320 in FIG. 3.

Similarly, feed pipe 406 and input pressure 408 correspond to pipe class 322 and pressure attribute 324 respectively in FIG. 3, and form one business object instance of pipe class 322. Output pipe 410 and output pressure 412 also correspond to pipe class 322 and pressure attribute 324 respectively in FIG. 3, and form another business object instance of pipe class 322. As described with respect to FIG. 3, water distiller business object 402 has as its parts feed pipe business object 406 and output pipe 410.

Water temperature sensor 442 is an instantiation of temperature sensors class 342 or a derivative or modification thereof in FIG. 3. Water temperature sensor 442 provides temperature data to water temperature attribute 404 of water distiller business object 402.

Feed pressure sensor 444 is an instantiation of pressure sensors class 344 or a derivative or modification thereof in FIG. 3. Feed pressure sensor 444 provides input pressure data to input pressure attribute 408 of feed pipe business object 406.

Output pressure sensor 446 is another instantiation of pressure sensors class 344 or a derivative or modification thereof in FIG. 3. Output pressure sensor 446 provides output pressure data to output pressure attribute 412 of output pipe business object 410.

By relating objects 402-446 in this manner, an improved modeling tool, such as improved modeling tool 103 in FIG. 1, creates a portion of actionable business entity operating model of an embodiment. Specifically, business objects 402, 406, and 410 become self-updating simply through relationship declarations in the improved modeling tool, and without requiring custom coding on the part of an operator of the business environment.

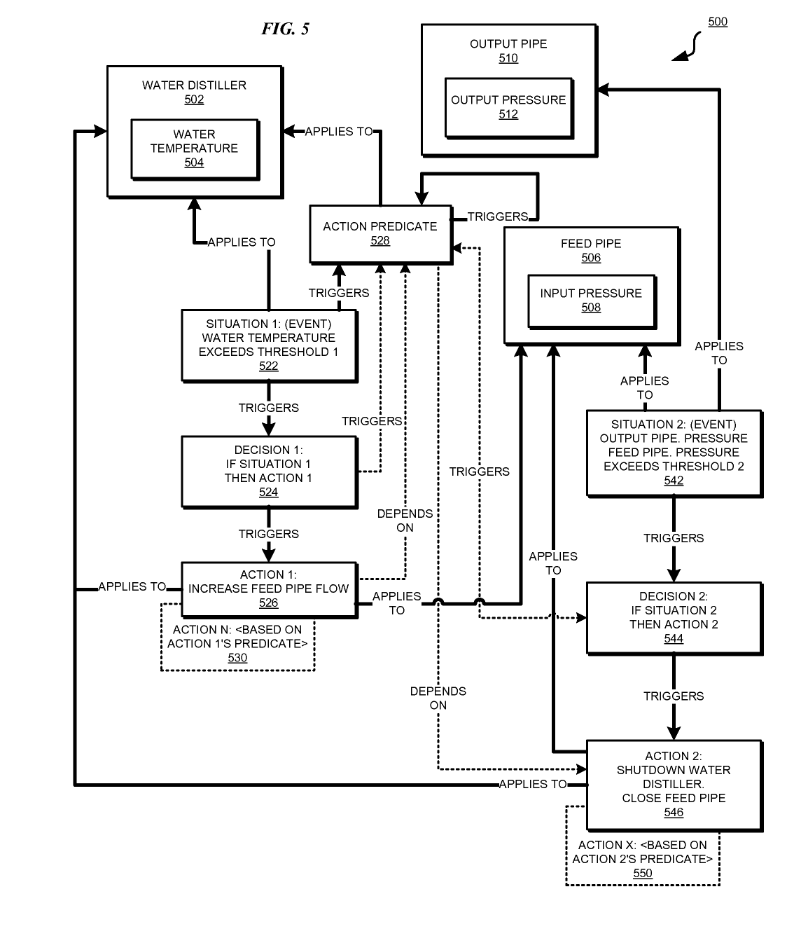

With reference to FIG. 5, this figure depicts an example configuration of actionable business objects in an actionable business entity operating model in accordance with an illustrative embodiment. In actionable business entity operating model 500, water distiller business object 502 and water temperature attribute 504 in water distiller business object 502 correspond to business object 402 and attribute 404 respectively in FIG. 4.

Feed pipe business object 506 and input pressure attribute 508 in feed pipe business object 506 correspond to business object 406 and attribute 408 respectively in FIG. 4. Output pipe business object 510 and output pressure attribute 512 in output pipe business object 510 correspond to business object 410 and attribute 412 respectively in FIG. 4. Other objects, such as objects 442, 444, and 446 of FIG. 4 are also present in actionable business entity operating model 500, but are not depicted in this figure for clarity.

Object 522 labeled “Situation 1” is an instantiation of event class 362 in FIG. 3, and defines an event that can occur in a given business environment. As an example, continuing with the example business environment of an oil and gas industry, setup in FIG. 3 et seq., Situation 1 arises in the business environment when a value in water temperature attribute 504 of water distiller business object 502 exceeds a threshold, “Threshold 1”.

The instrumentation of class 362 in FIG. 3 is already setup to trigger certain functions of classes 364, 366, 368, or a combination thereof. Thus, when object 522 evaluates Situation 1 to be true in the given business environment, object 522 triggers, or instantiates, object 524, which is an instantiation of decision class 364 in FIG. 3, and is labeled “Decision 1”. For example only, object 522 is shown to also trigger object 528, which is an instantiation of predicate class 366 in FIG. 3.

The instrumentation of class 364 in FIG. 3 is setup to trigger certain functions of classes 366, 368, or a combination thereof. Accordingly, after Decision 1 is triggered by Situation 1, Decision 1 triggers object 526, object 528, or both. Object 526 is an instantiation of action class 368 in FIG. 3, and is labeled “Action 1”. Object 528 is an instantiation of predicate class 366 in FIG. 3, and is labeled “Action Predicate”. Another action, for example, object 530 labeled “Action N” may be triggered by Action Predicate object 528.

Action 1 object 526 has an “applies to” relationship with water distiller business object 502 because the action implemented in Action 1 affects water distiller business object 502. As an example, in one embodiment, Action 1 object 526 implements a flow restriction action, such as by actuating valves in feed pipe business object 506. Therefore, Action 1 object 526 also “applies to” feed pipe business object 506.

In a similar manner, event object 542 labeled “Situation 2” defines another event that can occur in the given business environment. As an example, Situation 2 arises in the business environment when a value in output pressure attribute 512 of output pipe business object 510 exceeds a value in input pressure attribute 508 of feed pipe business object 506 by a threshold, “Threshold 2”. As with event object 522, Situation 2 event object 542 triggers decision object 544 labeled “Decision 2”, which triggers action object 546 labeled “Action 2”. Additional action objects, such as action object 550 labeled “Action X”, may also be triggered as a consequence of the instrumentation in an action predicate object (not shown) of Action 2 object 546.

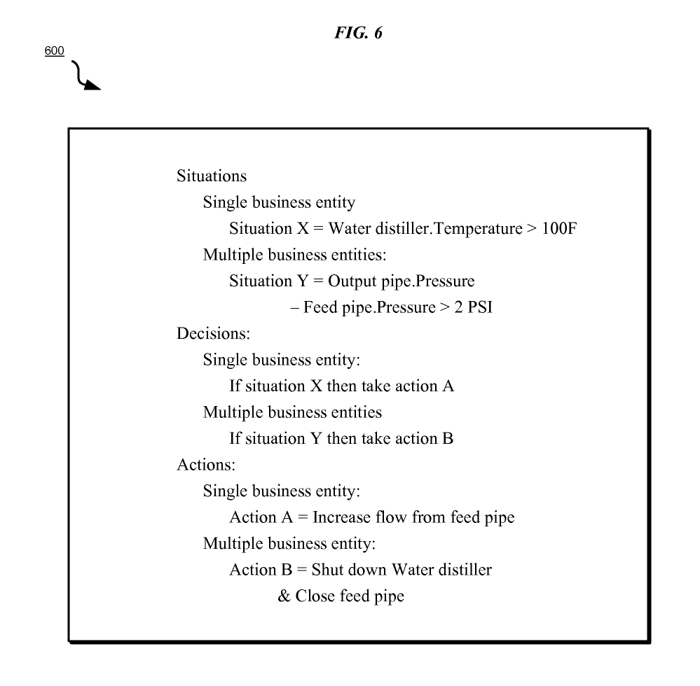

With reference to FIG. 6, this figure depicts an example of declarative statements replacing custom coding in an actionable business entity operating model in accordance with an illustrative embodiment. In one embodiment, an improved modeling tool, such as improved modeling tool 103 in FIG. 1, allows an operator to visually relate the various objects in the manner of FIG. 5. In another embodiment, the improved modeling tool allows the operator to specify the declarative statements 600 in the non-code form as depicted in FIG. 6. Another embodiment allows the operator to visually specify the relationships and creates declarative statements 600 in non-code form, as shown, as a result. Thus, advantageously, an embodiment allows specifying the “applies to”, “triggers”, “depends on”, “has part”, and other relationships depicted in FIG. 3 et seq. merely by declarative statements and without requiring custom coding thereof.

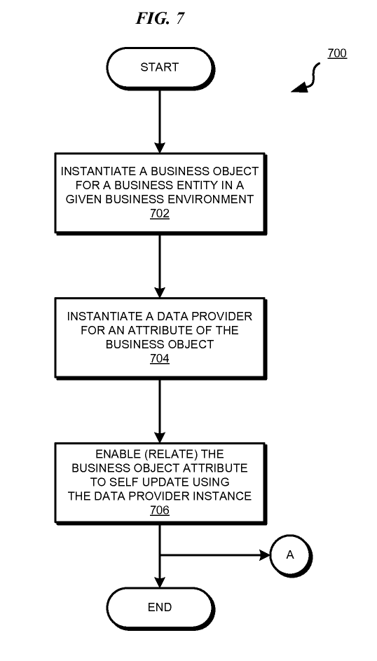

With reference to FIG. 7, this figure depicts a flowchart of an example process of creating a self-updating business object for an actionable business entity operating model in accordance with an illustrative embodiment. Process 700 can be implemented in an improved modeling tool, such as improved modeling tool 103 in FIG. 1.

The improved modeling tool instantiates a business object for a business entity in a given business environment (block 702). The improved modeling tool instantiates one or more data provider objects for supplying data to one or more attributes of the business object (block 704). The improved modeling tool enables the business object attribute to self-update using the data provider instance by relating the business object attribute with the data provider instance in the manner described above (block 706).

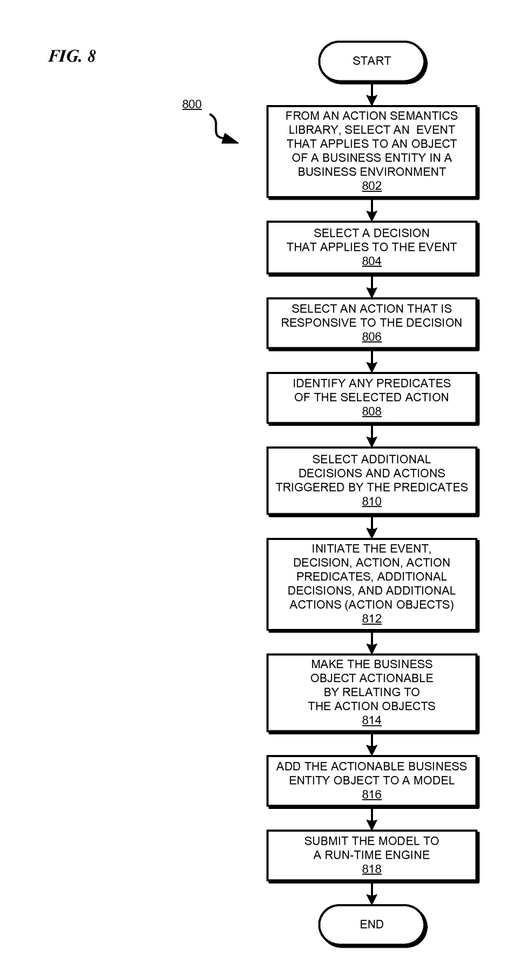

The improved modeling tool may end process 700 thereafter, or exit process 700 at exit point “A” to enter process 800 in FIG. 8 at a corresponding entry point “A”.

With reference to FIG. 8, this figure depicts a flowchart of an example process of creating an actionable business entity operating model in accordance with an illustrative embodiment. Process 800 can be implemented in an improved modeling tool, such as improved modeling tool 103 in FIG. 1.

The improved modeling tool begins process 800, or enters process 800 via entry point “A” from process 700. From an action semantics library, such as action semantics library 306 in FIG. 3, the improved modeling tool selects an event that applies to an object of a business entity in a given business environment (block 802). The improved modeling tool selects a decision that applies to the event (block 804). The improved modeling tool further selects an action that is responsive to the selected decision (block 806).

The improved modeling tool identifies any predicates of the selected action (block 808). The improved modeling tool selects additional decisions, actions, or a combination thereof that can be triggered by the predicates (block 810).

The improved modeling tool instantiates the event, the decision, the action, the action predicates, the additional decisions, and the additional actions (collectively, action objects) (block 812). The improved modeling tool makes the business object, such as the business object created and made self-updating in process 700 of FIG. 7, actionable (block 814). Specifically, the improved modeling tool makes the business object actionable by relating the business object with one or more action objects using declarative statements or visual artifacts according to an embodiment herein.

The improved modeling tool adds the actionable business object to a model, thereby creating an actionable business entity operating model (block 816). The improved modeling tool submits the model to a runtime engine, such as an interpreter or runtime engine 109 in FIG. 1 (block 818). The improved modeling tool ends process 800 thereafter.

The runtime engine interprets the actionable business entity operating model according to the given business environment. The runtime engine further manipulates a business entity in the given business environment responsive to the interpretation of the actionable business entity operating model, or causes a business entity in the given business environment to be manipulated in response to the interpretation of the actionable business entity operating model.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide a method, system, and computer program product for creating an actionable business entity operating model. An embodiment allows operators of business environments to declaratively define events and actions occurring in their business environments, without requiring the operators to custom code those events or actions.

An embodiment further formalizes the notion of operational decisions, and when those decisions apply. An embodiment triggers actions as a result of applying those decisions, including resolving action dependencies and executing the action predicates. An embodiment can further allow operational monitoring systems to provide adaptable dashboards that reconfigure the information presented thereon in response to the declaratively defined relationships and actuations in the actionable business entity operating model. An embodiment enables these and other functions by using a generalized non code type language, such as natural language, and interpreting the generalized language statements using an existing interpreter. Web Ontology Language (OWL) is an example natural language that is usable for this purpose.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a wide area network (WAN), or a mobile ad hoc network (MANET), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational blocks to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, a set includes one or more members unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for creating an actionable business environment model, the method comprising:
a computer instantiating a business object according to a business entity subclass, the business entity subclass representing an asset in a business environment;
the computer instantiating an event object, wherein an event represented in the event object applies to the business object;
the computer instantiating a decision object, wherein the decision object includes logic to take an action in response to the event;
the computer instantiating an action object, wherein the action object includes logic to respond to the event by interacting with the business object;
the computer making the business object actionable by relating the business object to a combination of the event object, the decision object, and the action object using a declarative statement; and
the computer adding the actionable business object to a model, thereby creating the actionable business environment model.

2. The method of claim 1, further comprising:
the computer constructing the declarative statement using a language that is interpreted by a runtime engine, wherein interpreting the declarative statement causes actuation of the asset in the business environment.

3. The method of claim 2, wherein the language is natural language.

4. The method of claim 1, further comprising:
the computer selecting a decision class from a library of predefined functions, wherein the decision object is an instance of the decision class, and wherein the decision class is instrumented to respond to a generic event relating to a generic business object.

5. The method of claim 1, further comprising:
the computer selecting an event class from a library of predefined functions, wherein the event object is an instance of the event class, and wherein the event class is instrumented to detect a generic event relating to a generic business object.

6. The method of claim 1, wherein the business entity subclass is a child of a business entity class, wherein the business entity class includes an interface with a data provider object and an interface with the action object.

7. The method of claim 6, further comprising:
the computer constructing a second declarative statement using a language that is interpreted by a runtime engine, wherein interpreting the second declarative statement causes an attribute of the business object to be updated using data from the data provider object.

8. The method of claim 7, wherein the data provider object represents a temperature sensor in the business environment, and wherein interpreting the second declarative statement by a runtime engine causes a value at the temperature sensor to be read in the business environment and further causes the asset to be manipulated in response to the value at the temperature sensor.

9. A method for configuring a business object in an actionable business environment model, the method comprising:
a computer instantiating a business object according to a business entity subclass, the business entity subclass representing an asset in a business environment;
the computer instantiating a data provider object, wherein the data provider object supplies data to an attribute of the business object; and
the computer relating the business object and the data provider object using a declarative statement, wherein the business object and the data provider object related using the declarative statement form a part of the actionable business environment model.

10. The method of claim 9, wherein the data provider object represents a temperature sensor in the business environment, and wherein interpreting the declarative statement by a runtime engine causes a value at the temperature sensor to be read in the business environment and further causes the asset to be manipulated in response to the value at the temperature sensor.

11. The method of claim 9, wherein the data provider object represents a pressure sensor in the business environment, and wherein interpreting the declarative statement by a runtime engine causes a value at the pressure sensor to be read in the business environment and further causes the asset to be manipulated in response to the value at the pressure sensor.

12. The method of claim 9, wherein the business environment is specific to an industry, and wherein the asset is an equipment used in the industry.

13. A computer program product for creating an actionable business environment model, the computer program product comprising:
one or more computer-readable tangible storage devices;
program instructions, stored on at least one of the one or more storage devices, to instantiate a business object according to a business entity subclass, the business entity subclass representing an asset in a business environment;
program instructions, stored on at least one of the one or more storage devices, to instantiate an event object, wherein an event represented in the event object applies to the business object;
program instructions, stored on at least one of the one or more storage devices, to instantiate a decision object, wherein the decision object includes logic to take an action in response to the event;
program instructions, stored on at least one of the one or more storage devices, to instantiate an action object, wherein the action object includes logic to respond to the event by interacting with the business object;
program instructions, stored on at least one of the one or more storage devices, to make the business object actionably by relating the business object to a combination of the event object, the decision object, and the action object using a declarative statement; and
program instructions, stored on at least one of the one or more storage devices, to add the actionable business object to a model, thereby creating the actionable business model.

14. The computer program product of claim 13, further comprising:
program instructions, stored on at least one of the one or more storage devices, to construct the declarative statement using a language that is interpreted by a runtime engine, wherein interpreting the declarative statement causes actuation of the asset in the business environment.

15. The computer program product of claim 14, wherein the language is natural language.

16. The computer program product of claim 13, further comprising:
program instructions, stored on at least one of the one or more storage devices, to select a decision class from a library of predefined functions, wherein the decision object is an instance of the decision class, and wherein the decision class is instrumented to respond to a generic event relating to a generic business object.

17. The computer program product of claim 13, further comprising:
program instructions, stored on at least one of the one or more storage devices, to select an event class from a library of predefined functions, wherein the event object is an instance of the event class, and wherein the event class is instrumented to detect a generic event relating to a generic business object.

18. The computer program product of claim 13, wherein the business entity subclass is a child of a business entity class, wherein the business entity class includes an interface with a data provider object and an interface with the action object.

19. The computer program product of claim 18, further comprising:
program instructions, stored on at least one of the one or more storage devices, to construct a second declarative statement using a language that is interpreted by a runtime engine, wherein interpreting the second declarative statement causes an attribute of the business object to be updated using data from the data provider object.

20. The computer program product of claim 19, wherein the data provider object represents a temperature sensor in the business environment, and wherein interpreting the second declarative statement by a runtime engine causes a value at the temperature sensor to be read in the business environment and further causes the asset to be manipulated in response to the value at the temperature sensor.

21. A computer program product for configuring a business object in an actionable business environment model, the computer program product comprising:
one or more computer-readable tangible storage devices;
program instructions, stored on at least one of the one or more storage devices, to instantiate a business object according to a business entity subclass, the business entity subclass representing an asset in a business environment;
program instructions, stored on at least one of the one or more storage devices, to instantiate a data provider object, wherein the data provider object supplies data to an attribute of the business object; and
program instructions, stored on at least one of the one or more storage devices, to relate the business object and the data provider object using a declarative statement, wherein the business object and the data provider object related using the declarative statement form a part of the actionable business environment model.

22. The computer program product of claim 21, wherein the data provider object represents a temperature sensor in the business environment, and wherein interpreting the declarative statement by a runtime engine causes a value at the temperature sensor to be read in the business environment and further causes the asset to be manipulated in response to the value at the temperature sensor.

23. The computer program product of claim 21, wherein the data provider object represents a pressure sensor in the business environment, and wherein interpreting the declarative statement by a runtime engine causes a value at the pressure sensor to be read in the business environment and further causes the asset to be manipulated in response to the value at the pressure sensor.

24. The computer program product of claim 21, wherein the business environment is specific to an industry, and wherein the asset is an equipment used in the industry.

25. A computer system for creating an actionable business environment model, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to instantiate a business object according to a business entity subclass, the business entity subclass representing an asset in a business environment;
program instructions, stored on at least one of the one or more storage devices for execution by at least one of the one or more processors via at least one of the one or more memories, to instantiate an event object, wherein an event represented in the event object applies to the business object;
program instructions, stored on at least one of the one or more storage devices for execution by at least one of the one or more processors via at least one of the one or more memories, to instantiate a decision object, wherein the decision object includes logic to take an action in response to the event;
program instructions, stored on at least one of the one or more storage devices for execution by at least one of the one or more processors via at least one of the one or more memories, to instantiate an action object, wherein the action object includes logic to respond to the event by interacting with the business object;
program instructions, stored on at least one of the one or more storage devices for execution by at least one of the one or more processors via at least one of the one or more memories, to make the business object actionably by relating the business object with a combination of the event object, the decision object, and the action object using a declarative statement; and
program instructions, stored on at least one of the one or more storage devices for execution by at least one of the one or more processors via at least one of the one or more memories, to add the actionable business object to a model, thereby creating the actionable business environment model.

26. A computer system for configuring a business object in an actionable business environment model, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to instantiate a business object according to a business entity subclass, the business entity subclass representing an asset in a business environment;
program instructions, stored on at least one of the one or more storage devices for execution by at least one of the one or more processors via at least one of the one or more memories, to instantiate a data provider object, wherein the data provider object supplies data to an attribute of the business object; and
program instructions, stored on at least one of the one or more storage devices for execution by at least one of the one or more processors via at least one of the one or more memories, to relate the business object and the data provider object using a declarative statement, wherein the business object and the data provider object related using the declarative statement form a part of the actionable business environment model.
